(19) United States
(12) Patent Application Publication
(10) Pub. No.: US 2007/0034329 A1
(43) Pub. Date: Feb. 15, 2007

(54) Heat-sealing method and device for implementing same

(76) Inventor: Jean-Claude Padoy, Valeyres-sous-Montagny (CH)

Correspondence Address: DAVIS & BUJOLD, P.L.L.C., 112 PLEASANT STREET, CONCORD, NH, 03301, US

(21) Appl. No.: 10/573,669

(22) PCT Filed: Sep. 24, 2004
(86) PCT No.: PCT/CH04/00600

§ 371 Date: Mar. 29, 2006

(30) Foreign Application Priority Data
Sep. 30, 2003 (FR) 0311533

(51) Int. Cl. B32B 37/00

(52) U.S. Cl. 156/274.4; 156/311; 156/359

(57) ABSTRACT

The invention relates to a device which is used for the heat-sealing of a thermoplastic synthetic film to a thermoplastic synthetic container. The inventive device has at least one thermal electrode (11) which is made from a material with high thermal conductivity. The electrode is equipped with a metal section (30) having electrical connection terminals (31) at its ends. A heat flux sensor (32) comprising two electrical connections (33) is also provided, and the lower face is fixed mechanically to the upper part of the above-mentioned section (30). In addition, the upper face of the heat flux sensor (32) is fixed to the lower face of a thermal capacitor (34) which is made from a material with high thermal diffusivity and conductivity. Furthermore, a thermocouple (35) is mounted in a cavity in the metal section (30).

This application is a national stage completion of PCT/CH2004/000600 filed Sep. 24, 2004 which claims priority from French Application Serial No. 0311533 filed Sept. 30, 2003.

### TECHNICAL DOMAIN

The instant invention concerns a method for heat-sealing at least one film of synthetic thermoplastic material to a container made of at least one synthetic thermoplastic material, particularly a container for packaging products that are susceptible to microbiological contamination, more specifically, biological or perishable commodities such as agricultural produce, said method using at least a first and a second thermal electrode.

It also concerns a device for heat-sealing at least one film of synthetic thermoplastic material onto a container made of at least one synthetic thermoplastic material, particularly a container for packaging products susceptible to microbiological contamination, more specifically, biological or perishable commodities such as agricultural produce, using at least a first and a second thermal electrode to implement this method.

### PRIOR ART

Numerous packages, particularly those designed for packaging food produce, are formed of a pouch consisting of two thermoplastic films sealed together or formed of a container made of one or more synthetic materials manufactured by heat-sealing and closed by sealing thermoplastic film onto the container using heating electrodes. Although steady improvements have been made with respect to barrier-type films, the weakest link in package sealing remains the joining of thermoplastic films to each other or joining a thermoplastic film or lid to a thermoplastic package. At high speed and using current techniques, neither the seal nor consumer safety standards relative to the microbiological aspect of food packaging are completely satisfactory.

Thermoplastic film is normally composed of a sealing layer which, after heating and at a given pressure, forms tight contact with the other portion to which it is joined. During contact, heat sufficient to bring the sealing layer to its melting point is transmitted to the materials. The pressure maintained during sealing crushes the sealing layer, which spreads and thins out. When the thin layer of sealing material crystallizes upon application of some sort of mechanical constraint, it sometimes pulls away, causing the formation of cracks which destroy the microbiological integrity of the packaging.

The principal problems contributing to this result have been identified.

They relate primarily to the heat. Heat regulation is essentially arbitrary, with the result that there is little control over the energy transmitted by the thermal electrodes to the material, causing the sealing layer to possibly overheat, spread excessively, and leading to increased shrinkage by the material. Furthermore, the randomness of the heat control also results in excessively long production cycles, detracting from the efficiency of the production line.

Various techniques exist for sealing film with heat, for example, the use of heating bars, hot wires, or heat impulsion. These different techniques are not suitable for all types of polymers used as synthetic heat-sealable material. It is necessary to take into account the surfaces to be sealed, their various thicknesses, the coating on the materials, etc. The high speeds requirements of current production techniques often limit sealing time to less than a second. The application of either excessive or insufficient amounts of heat detracts from the quality of sealing. Current technical improvements are principally based on more precise temperature control of the heating bars. Data on the behavior of sealed polymers is only available for laboratory settings using destructive protocols. There is currently no device for dynamic control of sealing on production lines.

The principal flaws of these known systems are due to:

Too much thermal inertia in the sealing systems;

Very low thermal stability of the sealing bars;

Too much pressure applied to the film to be heat-sealed;

Lack of control over the heat-sealing process on the line;

Lack of control over cooling the seal on the line; and

No regulation on the basis of the state of the synthetic material used.

### DESCRIPTION OF THE INVENTION

The instant invention proposes overcoming the disadvantages of the prior art by offering a high quality heat-sealing method that respects the microbiological integrity of a package.

At least the first electrode is stabilized by controlling the variation in thermal flux emitted by this electrode;

Temperature variation between the two electrodes is regulated by controlling the thermal flux flowing between said first and second electrodes, said thermal flux resulting from the temperature disequilibrium between the two electrodes and the variation in thermal resistance corresponding to the physical state of the synthetic thermoplastic material.

The pressure exerted by at least one of the electrodes on the synthetic thermoplastic material is regulated by controlling the instantaneous variation in thermal flux resulting from the thermal energy absorbed by the melting of the synthetic thermoplastic material.

A device for cooling the synthetic thermoplastic material is regulated by controlling the instantaneous variation of thermal flux resulting from the thermal energy restored by the synthetic thermoplastic material when it crystallizes.

Advantageously, said first thermal electrode is first stabilized and the temperature difference between the two electrodes is regulated by controlling the heat flux using at least one heat flux sensor associated with said thermal electrodes.

Preferably the pressure exerted by at least one thermal electrode on the synthetic thermoplastic material is regulated using at least one cylinder associated with this electrode and cooling of the synthetic thermoplastic material is regulated by chilling at least one of the thermal electrodes.

The device as defined in the preamble for implementing this method is characterized in that it comprises:

A means for stabilizing at least the first thermal electrode by controlling the variation in heat flux emitted by said electrode;

A means for regulating the temperature difference between the two electrodes by controlling the heat flux flowing between the first and the second electrode, said heat flux resulting from the temperature disequilibrium between the two electrodes and the variation in thermal resistance corresponding to the physical state of the synthetic thermoplastic material;

A means for regulating the pressure exerted by at least one of the electrodes on the synthetic thermoplastic material by controlling the instantaneous variation in heat flux resulting from the thermal energy absorbed by the melting of the synthetic thermoplastic material; and

A means for regulating a device for cooling the synthetic thermoplastic material by controlling the instantaneous variation in heat flux resulting from the thermal energy restored by the synthetic thermoplastic material when it crystallizes.

In a preferred form of embodiment said means for stabilizing at least said first thermal electrode by controlling the variation in heat flux emitted by said electrode comprises a heat flux sensor and a thermal flux meter regulator associated with this thermal electrode.

In this same embodiment, said means for regulating a temperature differential between the two electrodes by controlling the heat flux flowing between said first and said second electrode, said heat flux resulting from the temperature disequilibrium existing between the two electrodes and the variation in thermal resistance corresponding to the physical state of the synthetic thermoplastic material, comprises at least one heat flux sensor associated with each of the thermal electrodes and a thermal flux meter regulator connected to these sensors and to these electrodes.

Advantageously, said means for regulating the pressure exerted by at least one of said electrodes on the thermoplastic material by controlling the instantaneous variation of heat flux resulting from the thermal energy absorbed by the melting of the synthetic thermoplastic material comprises a cylinder associated with said thermal electrode.

Preferably said means for regulating a device for cooling the synthetic thermoplastic material by controlling the instantaneous heat flux variation resulting from the thermal energy restored by the synthetic thermoplastic material when it crystallizes comprises at least one cooling channel formed inside at least one of said thermal electrodes.

In an advantageous embodiment, at least one of the thermal electrodes comprises a heating bar.

According to a variation, at least one of the thermal electrodes may comprise a thermal capacitor.

Preferably at least one of the thermal electrodes is attached to a flexible block and housed inside said flexible block which is attached to a support on the heat sealing device.

Advantageously said thermal electrode may comprise an integrated resistor element.

Said device is not intended uniquely for controlling and guiding the sealing of food packaging, but for any thermoplastic film sealing process where improved sealing quality is sought. Its applications are broad and may extend to medical devices (transfusion pouches), or to thick injected containers and lids, for example. It is also possible with this device to control the strength of seal delamination and peeling.

### SUMMARY DESCRIPTION OF THE DRAWINGS

The features of the present invention will be more apparent from the following description of different modes of implementing the method and different embodiments of the device of the invention, with reference to the attached drawings, in which:

FIG. 1 is a schematic view of a heat-sealing device;

FIGS. 1A and 1B are perspectives of two embodiments of thermal electrodes that can be used with the heat-sealing device of FIG. 1;

FIG. 2 is a cross-section of one example of films made of synthetic thermoplastic material constituting multi-layer heat-sealable materials;

FIG. 2A is a cross-section of a package comprising a thermo-formed container and a heat-sealed lid;

FIG. 3 is an elevation of a first embodiment of a thermal electrode that can be used with the device of FIG. 1;

FIG. 3A is a cross-section of said first embodiment of a thermal electrode shown in FIG. 3;

FIG. 4 is an elevation of a second embodiment of a thermal electrode that can be used with the device of FIG. 1;

FIG. 4A is a cross-section of said second embodiment of a thermal electrode shown in FIG. 4;

FIG. 5 is an elevation of a third embodiment of a thermal electrode that can be used with the device of FIG. 1;

FIG. 5A is a cross-section of said third embodiment of a thermal electrode shown in FIG. 5;

FIG. 6 is an elevation of a fourth form of embodiment of a thermal electrode that can be used with the device of FIG. 1;

FIG. 7 is a view showing the zone where the two heat-sealable materials are joined;

FIG. 8 is a view illustrating the heat-sealing principle for two heat-sealable materials at the same temperature;

FIG. 8A is a view showing the heat-sealing principle for two heat-sealable materials at different temperatures;

FIG. 9 illustrates the heat-sealing device equipped with its heat flux control and regulation elements;

FIG. 10 represents profile views of the thermal electrodes in the sealing zones;

FIGS. 11 through 13 represent various forms of seals that can be obtained; and

FIG. 14 represents a particular application of the heat-sealing device according to the invention.

### HOW TO ACHIEVE THE INVENTION

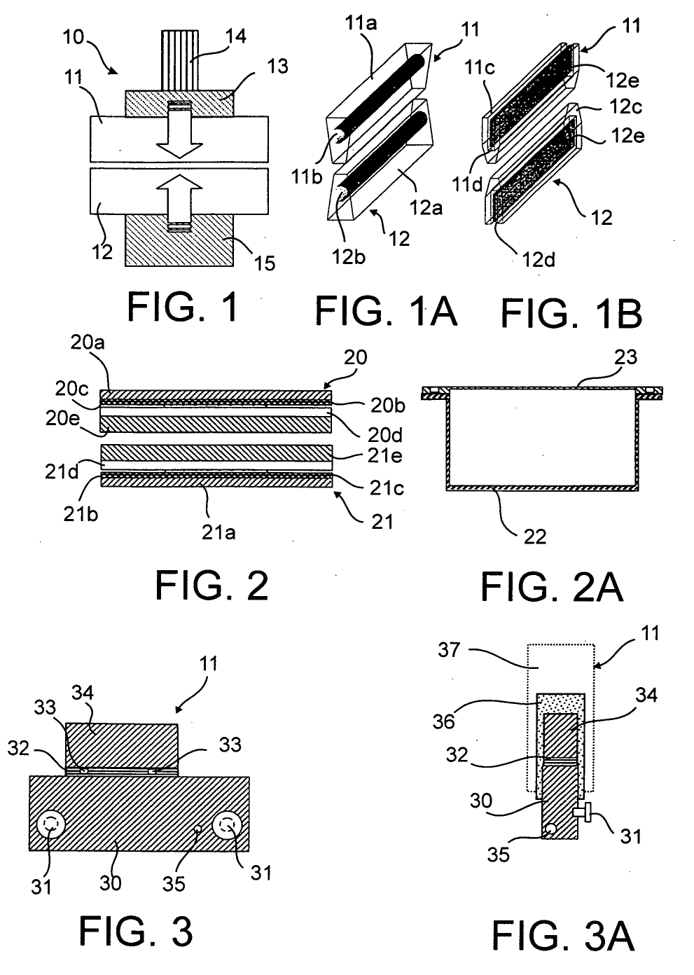

With reference to FIG. 1 the heat-sealing device 10 shown may comprise two thermal electrodes 11 and 12. A single thermal electrode may suffice for certain applications. These electrodes are generally made of a highly heat-conductive material such as, for example, aluminum or copper. Electrode 11 is held by a support 13 that is mounted on a pneumatic or electric pressure cylinder 14. Electrode 12 is rigidly attached to a support 15 integral with the machine frame (not shown). Support 15 may also be attached to a cylinder for certain specific applications.

FIG. 1A shows a first embodiment of thermal electrodes 11 and 12. They comprise a metal bar 11a and 12a each containing at least one integrated resistor element such as a heating wire 11b, 12b, respectively, or a heating stick, or the like.

FIG. 1B shows a second embodiment of thermal electrodes 11 and 12. They are in the form of blades 11c and 12c with a longitudinal slot 11d, 12d, respectively, covered with a heat-resistant film 11e, 12e, respectively.

The temperature of thermal electrodes 11 and 12 is regulated on the basis of data furnished by sensors measuring the thermal energy required to effect heat-sealing.

As shown in FIG. 2, films 20 and 21 to be sealed are, for example, multi-layer films and may comprise a first exterior barrier layer 20a, 21a respectively, a first impression layer 20b, 21b, respectively, a second impression layer 20c, 21c, respectively, a second interior barrier layer 20d, 21d, respectively, and a sealing layer 20e, 21e, respectively. The sealing layer has a lower melting temperature T_{F} lower than the other layers, particularly the barrier layers. The two contacting sealing layers 20e and 21e are sealed when they begin to melt, ensuring the cohesion of the unit.

FIG. 2A illustrates a package comprising a container 22 made from heat-formed or injected material and a barrier film 23 serving as a lid. This barrier film could also be replaced by an injected cover. Sealing can be effected with a single electrode applied to the lid, the sealing zone on container 22 having been previously preheated using hot air or an infrared beam.

FIGS. 3 and 3A respectively illustrate an elevation and a cross-section of an embodiment of a thermal electrode called the sealing electrode 11 of device 10. It consists essentially of a metal section 30 that may be several millimeters wide and of variable length. It is made of electrically resistant material, for example, ferro-nickel that may or may not be coated with Teflon® film. Electrical connecting terminals 31 are located at the extremities of section 30. A heat flux sensor 32 is mechanically attached by its lower surface to the upper portion of section 30. Heat flux sensor 32 has two electrical connections 33. The upper surface of heat flux sensor 32 is attached to the lower surface of a thermal capacitor 34 made of material with high thermal conductivity and diffusivity. A thermocouple 35 is mounted in a cavity formed in metal section 30.

FIG. 3A shows more detail of the unit attached to a support connected to the heat-sealing device. Thermal capacitor 34 is housed in a flexible block 36 made of electrically insulating thermal material, for example, silicon rubber, said block being housed inside a recess in support 37 integral with the heat-sealing device. The unique feature of this flexible assemblage is its ability to overcome the tendency of thermal electrodes to be slippery.

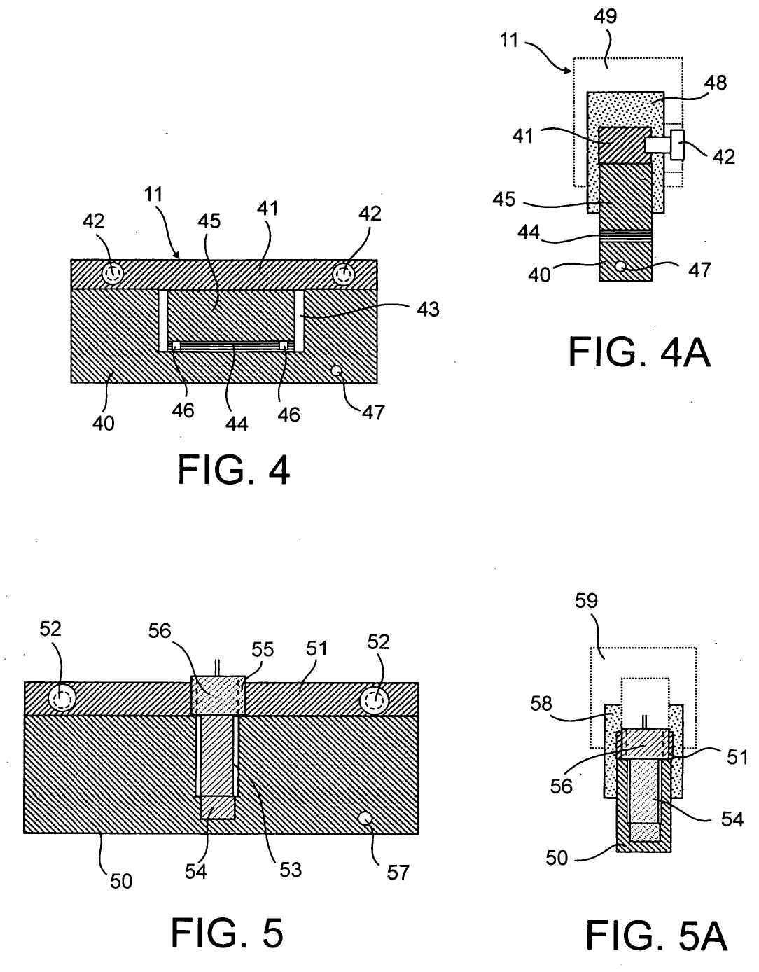

FIGS. 4 and 4A represent another embodiment of a thermal electrode, called sealing electrode 11, of device 10. This sealing electrode consists of a metal section 40 made of thermally conductive and highly diffusive material joined to a heating bar 41 made of electrically resistant material. This heating bar 41 is equipped with electrical connection terminals 42. The metal section 40 has a central groove 43 for housing a heat flux sensor 44, the lower portion of which is attached to the upper surface of metal section 40, and the upper surface of which is attached to thermal capacitor 45 made of the same material as metal section 40 which constitutes the thermal electrode called the sealing electrode. Thermal capacitor 45 is joined below electrical heating bar 41. Heat flux sensor 44 has two electrical connections 46. A thermocouple 47 is attached to the inside of the sealing electrode.

FIG. 4A represents a cross-section of this thermal electrode. As with the embodiment in FIGS. 3 and 3A, the unit consisting of metal section 40, heating bar 41, thermal capacitor 45, and heat flux sensor 44 is housed in a flexible block 48. Flexible block 48 itself is housed in a support element 49 for the heat-sealing device. The unique feature of this flexible assemblage is its ability to overcome the tendency towards slipperiness during heat-sealing.

FIGS. 5 and 5A represent another embodiment of this thermal electrode, called a sealing electrode, that consists of a metal section 50 made of thermally conductive, highly diffusive material. Said section 50 is joined to heating bar 51 made of electrically resistant material. At its extremities heating bar 51 is equipped with electrical connection terminals 52. Metal section 50 has a groove 53 for receiving a heat flux sensor 54. A threaded groove 55 traverses heating bar 51 coaxially in relation to groove 53 to receive head 56 of heat flux sensor 54. A thermocouple 57 is attached in a suitable housing in the sealing electrode consisting of metal section 50.

FIG. 5A shows how this thermal electrode is attached. Note that heating bar 51 and the metal section are housed in a flexible block 58, with the block itself housed in a support element 59 for the heat-sealing device. The unique feature of this flexible assemblage is its ability to overcome the slipperiness of the elements intervening directly in the heat-sealing process, i.e. the sealing electrode or electrodes and/or the opposing contact element, as the case may be.

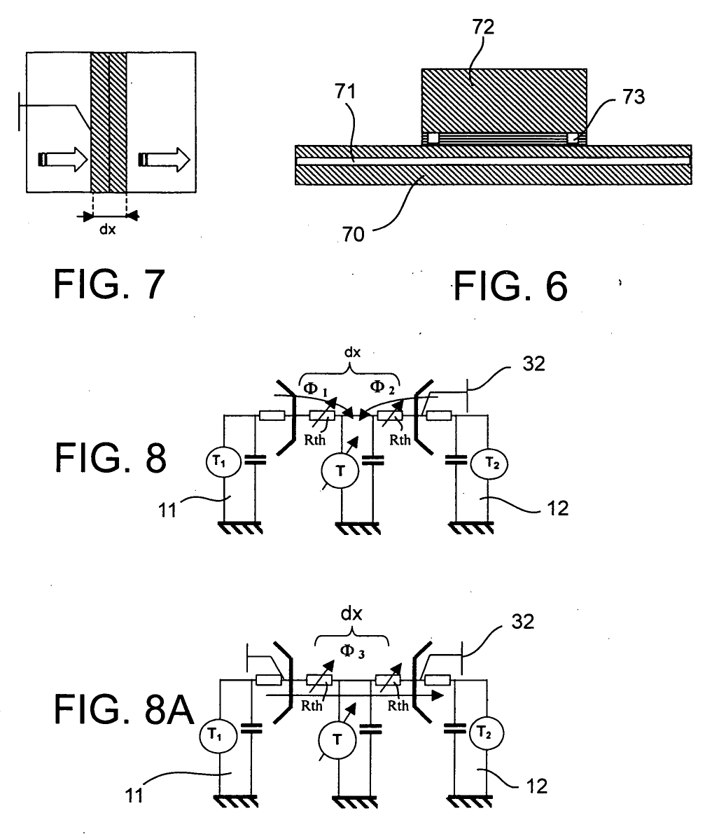

FIG. 6 shows another embodiment of the thermal electrode called the sealing electrode. It consists of a metal section 70 comprising an interior channel 71 through which cooling fluid circulates on command. The purpose of this channel for the flow of cooling liquid is to control temperature and more specifically, thermal energy transmitted to the material for heat-sealing, thereby regulating the crystallization rate of this material in the sealing zone as it cools.

This regulation is particularly important with large seals. Metal section 70 is associated with a thermal capacitor 72. A heat flux sensor 73 is attached between the metal section 70 and thermal capacitor 72.

The operation of the heat-sealing electrodes is based on the following principle: when two thermoplastic materials are joined with heat, gradient pressure ΔP is applied so as to create a tight contact between these materials. The tight contact created in this way is necessary for the passage of quantities of heat ΔQ transmitted by the sealing electrodes, which may be from the hot zones at a temperature T₁ towards the compressed thermoplastic material constituting the cold zone at a temperature T₂ lower than T₁. The quantities of heat are stored in the thermoplastic material and cause its temperature to rise. The temperature rises until it attains the temperature T_{F} at which heat sealing materials melt.

From this point on, several phenomena occur. The first one is desirable, that is, auto-adhesion, which is very rapid, of the order of several milliseconds, ensuring molecular bonding between the two materials in the sealing zone.

The second one undesirable, that is, flowing, which, due to the sudden change in viscoelasticity in the pressurized sealing zone, tends to reduce the thickness of the material in this same zone, making it mechanically fragile.

The third one is the formation of the seal that begins with the cooling of the materials in the sealing zone. At this stage it is known that if cooling can be controlled, the crystallization rate (X_{C}%) can also be controlled as a function of the slope of the cooling curve. The crystallization rate of the materials affects recrystallization and the shrinking phenomenon that may lead to formation of cracks and serious microbiological flaws in the heat-sealed package when it may subsequently be exposed to mechanical constraints.

The challenge in heat-sealing consists of regulating these various phenomena. To accomplish this, the invention proposes to effect real time control over the exchange of quantities of heat flowing at a variable rate. According to the prior art, the temperatures were controlled, that is, the final condition, making real time regulation difficult or even impossible.

As shown in FIG. 7, in a variable pattern, heat accumulates over a period of time dt in sealing zone dx at temperatures that vary over time. When sealing zone dx reaches the melting temperature T_{F} of the material, sealing zone dx is the location of energy absorption −PI.

When sealing zone dx cools down and reaches the crystallization temperature T_{c}, it becomes the location of energy restoration +PI. This variable pattern can be detected with a heat flux sensor correctly positioned on the thermal electrode.

FIG. 8 presents a symbolic schematic of a heat-sealing device. During time t+a the equivalent thermal capacity Cp of the heat-sealable materials is charged by sealing electrodes 11 and 12 with quantities of heat ΔQ flowing from the hottest point of electrodes 11 and 12 toward the coldest point, sealing zone dx. Heat fluxes φ₁ and φ₂ migrate from thermal electrodes 11 and 12 towards sealing zone dx through thermal resistors Rth. A heat flux sensor 32 measures the variation in thermal flux. The heat fluxes are equal when the temperature of electrodes 11 and 12 is identical, such that T₁=T₂ and are then nullified when the materials are charged.

In the example in FIG. 8A thermal electrodes 11 and 12 are no longer at the same temperature. For example T₁>T₂ The charging fluxes are different: φ₁>φ₂. When the materials are charged, the thermal flux rate is no longer nil. A quantity of heat flow φ₃ is established from the hottest electrode 11 at temperature T₁ toward the coldest electrode at temperature T₂ through sealing zone dx. The flux level φ₃ is a function of the difference in temperature between electrodes ΔT=T₁−T_{2.}

A heat sensor 32 correctly positioned on electrode 12 will detect a flow φ₂ as the material begins charging, and when it has been charged, an inverse flux φ₃.

By fixing the temperature of one of the thermal electrodes at a higher value than the melting temperature T_{F} in the sealing zone dx and the temperature of the other thermal electrode at a lower value, the resulting heat flux detected by the heat flux sensor varies constantly as a function of small temperature differences, with the result that for the purpose sought, either the delaminating force or the peeling force is modified, which risks breaking the fragile mechanical seal. This can be overcome and the delaminating and peeling forces stabilized depending upon the various properties of the materials and the environment on the one hand, by regulating the temperature of one electrode using a heat flux regulator operating on the basis of data furnished by the heat flux sensor associated with it and delivering through this electrode only the necessary and sufficient quantities of heat; and on the other hand, by regulating the temperature of the other thermal electrode using a heat flux regulator operating on the basis of data furnished by the heat flux sensor associated with it and delivering through this electrode only the necessary and sufficient quantities of heat.

It is therefore possible to make a controlled lid for a package and to regulate the strength of the seal by controlling either the force of delaminating or of peeling through the use of a heat flux regulator to control the thermal electrodes.

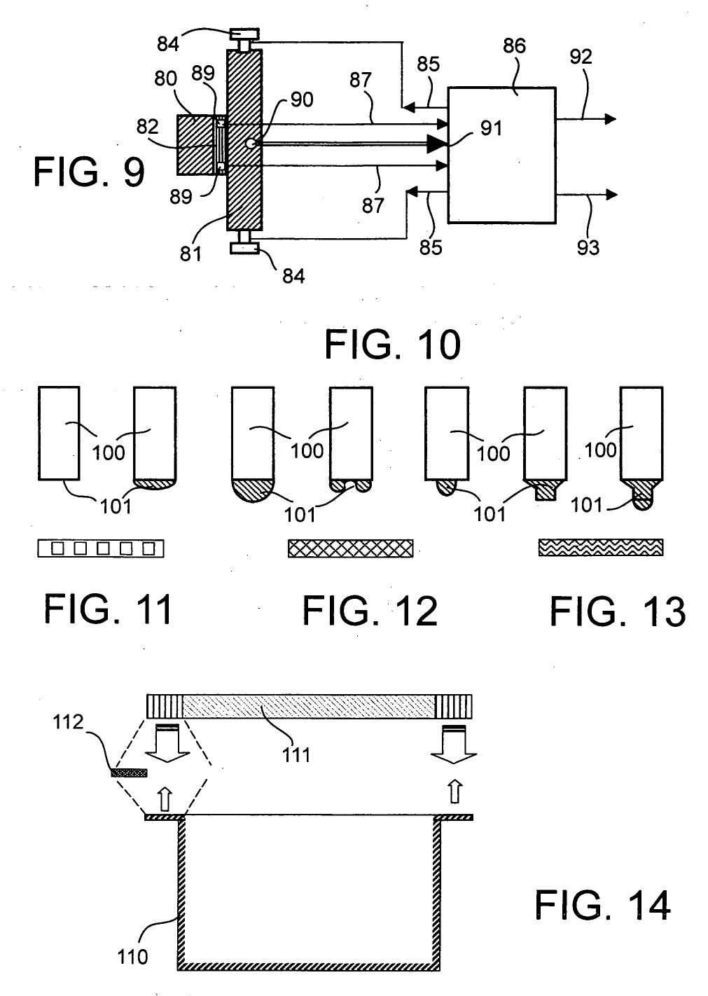

FIG. 9 is a schematic illustration of the means for regulating a thermal electrode 80 associated with a heating bar 81 as a function of the data communicated by heat flux sensor 82. The connecting terminals 84 on heating bar 81 are connected at outputs 85 of a thermofluximetric regulator 86, heat flux sensor 82 is connected to inputs 87 of thermofluximetric regulator 86 by means of its connectors 89, and thermocouple 90 is connected to input 91 of thermofluximetric regulator 86.

Flow is prevented in the sealing zone by using heat flux sensor 82 to detect melting in the zone, with the sensor delivering data processed by thermofluximetric regulator 86 which generates on opto-coupled circuit 92 a signal that passes from 0 to 1. This signal reduces the gradient pressure ΔP of cylinder 14 (see FIG. 1) on the sealing zone. An opto-coupled output 93 on thermofluximetric regulator 86 passes from 0 to 1 at the same time. This signal controls injection into channel 71 (see FIG. 6) on the thermal electrode of a cooling fluid during seal formation.

FIG. 10 illustrates a series of thermal electrodes 100 with distinct profiles, the sealing surfaces 101 of which may have various possible configurations depending upon the desired application.

FIGS. 11 through 13 illustrate different types of sealing zones obtained using different electrodes. FIG. 11 represents a sealing zone with spaced apart points, FIG. 12 represents a honeycomb sealing zone, and FIG. 13 represents a multilinear sealing zone.

In certain instances it is impossible to use juxtaposed thermal electrodes, especially when joining thick pieces, for example, a container 110 and a lid 111 as shown in cross-section in FIG. 14. In this case the sealing zone is heated in advance, either by infrared beam or by hot air heat convection.

The problems are identical to those described previously. The temperature of the surface of the sealing zone is regulated using a radiant type heat flux sensor 112 and a thermofluximetric regulator as described above.

1-14. (canceled)

15. A method of heat-sealing at least one synthetic film of thermoplastic material onto a container made of at least one synthetic thermoplastic material, particularly a container for packaging products that are susceptible to microbiological contamination, more specifically, perishable biological or commodities such as agricultural produce, using at least first and second thermal electrodes, the method comprising the steps of:
stabilizing at least the first thermal electrode by controlling a variation in a heat flux emitted by the first thermal electrode;
regulating a temperature difference between the first thermal electrode and the second thermal electrode by controlling a heat flux flowing between the first thermal electrode and the second thermal electrode, and the heat flux resulting from temperature disequilibrium existing between the first thermal electrode and the second thermal electrode and variation in thermal resistance corresponding to a physical state of the synthetic plastic material;
regulating pressure exerted on the synthetic thermoplastic material, by at least one of the first thermal electrode and the second thermal electrode, by controlling instantaneous variation in heat flux resulting from a thermal energy absorbed by melting of the synthetic thermoplastic material; and
regulating a device for cooling the synthetic thermoplastic material by controlling the instantaneous variation in the heat flux resulting from a thermal energy restored by the synthetic thermoplastic material when it crystallizes.

16. The method according to claim 15, further comprising the step of stabilizing the first thermal electrode and regulating a temperature difference between the first and second thermal electrodes by controlling heat fluxes using at least one heat flux sensor associated with the first and second thermal electrodes.

17. The method according to claim 15, further comprising the step of regulating the pressure exerted by at least one thermal electrode on the synthetic thermoplastic material by a cylinder associated with the at least one of the first and second thermal electrodes.

18. The method according to claim 15, further comprising the step of regulating cooling of the synthetic material by chilling at least one of the first and second thermal electrodes.

19. A device for heat-sealing at least one film of synthetic thermoplastic material onto a container made of at least one synthetic thermoplastic material, particularly a container for packaging products' susceptible to microbiological contamination, more specifically, perishable biological or commodities such as agricultural produce, using at least first and second thermal electrodes (11, 12), the device comprising:
a means for stabilizing at least the first thermal electrode (11) by controlling variation in heat flux emitted by the first thermal electrode;
a means for regulating a temperature difference between the first and the second thermal electrodes (11, 12) by controlling a heat flux flowing between the first electrode and the second electrode, and the heat flux resulting from the temperature disequilibrium between the first and the second thermal electrodes and variation in thermal resistance corresponding to a physical state of the synthetic thermoplastic material;
a means for regulating a pressure exerted by at least one of the first and second thermal electrodes onto the synthetic thermoplastic material by controlling an instantaneous variation in heat flux resulting from thermal energy absorbed by melting of the synthetic thermoplastic material;
a means for regulating a device for cooling the synthetic thermoplastic material by controlling the instantaneous heat flux variation resulting from thermal energy restored by the synthetic thermoplastic material when it crystallizes.

20. The device according to claim 19, wherein the means for stabilizing at least the first thermal electrode (80) by controlling the variation in heat flux emitted by the electrode comprises a heat flux sensor (82) and a thermofluximetric regulator (86) associated with the first thermal electrode.

21. The device according to claim 19, wherein the means for regulating the temperature difference between the first and the second thermal electrodes by controlling the heat flux flowing between the first and the second electrode, the heat flux resulting from the temperature disequilibrium between the first and the second electrodes and the variation in thermal resistance corresponding to the physical state of the synthetic thermoplastic material comprises at least one heat flux sensor associated with each of the first and second thermal electrodes and a thermofluximetric regulator connected to the heat flux sensors and to the first and second electrodes.

22. The device according to claim 19, wherein the means for regulating the pressure exerted by at least one of the first and second thermal electrodes onto the synthetic thermoplastic material by controlling the instantaneous variation in heat flux resulting from the thermal energy absorbed by the melting of the synthetic thermoplastic material comprises a cylinder (14) associated with the thermal electrode (11).

23. The device according to claim 19, wherein the means for regulating a device for cooling the synthetic thermoplastic material by controlling the instantaneous variation in heat flux resulting from restoration of thermal energy by the synthetic thermoplastic material as it crystallizes comprises at least one cooling channel (71) located inside at least one of the thermal electrodes (70).

24. The device according to claim 19, wherein at least one of the first and second thermal electrodes comprises a heating bar (41; 51; 81).

25. The device according to claim 19, wherein at least one of the first and second thermal electrodes comprises a thermal capacitor (34; 45; 72).

26. The device according to claim 19, wherein at least one of the first and second thermal electrodes is attached to a flexible block (36; 48; 58).

27. The device according to claim 26, wherein the thermal electrode is housed in flexible block which is attached to a support (37; 49; 59) on a heat-sealing device.

28. The device according to claim 19 wherein the first and the second thermal electrodes (11; 12) each comprise an integrated resistor element (11b; 11e; 12b; 12e).
